(19) United States
(12) Patent Application Publication
(10) Pub. No.: US 2010/0274658 A1
(43) Pub. Date: Oct. 28, 2010

(54) Payment Rewards

(75) Inventors: Casey Celli, Avondale, PA (US); Santiago Hernandez, Newark, DE (US); Michael A. Daly, Avondale, PA (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: BANK OF AMERICA CORPORATION, Charlotte, NC (US)

(21) Appl. No.: 12/754,870

(22) Filed: Apr. 6, 2010

Related U.S. Application Data
(60) Provisional application No. 61/172,851, filed on Apr. 27, 2009.

(51) Int. Cl. G06Q 30/00; G06Q 40/00

(52) U.S. Cl. 705/14.31

(57) ABSTRACT

A computer system enables a financial institution to award an account reward points when a customer remits a payment in a timely basis. Consequently, the financial institution encourages repayment of debt and recognizes good behavior through reward points every time a payment is received on-time. Each time a customer pays on-time, a credit card company may assign reward points to the customer's account for the amount of the payment. When a payment for a loan has been received in accordance with a reward policy, a number of reward points may be awarded to a customer that is dependent on a payment amount. For example, when the payment amount is at least as great as a minimum due and not greater than a balance due, setting the number of reward points to a constant multiplied by the payment amount. However, the reward points may be determined in a non-linear fashion.

### PAYMENT REWARDS

This application claims priority to provisional U.S. Application Ser. No. 61/172,851 (“Payment Awards”), filed Apr. 27, 2009.

### FIELD

Aspects of the embodiments relate to a computer system that provides an award to a consumer for a loan payment in accordance with a reward policy.

### BACKGROUND

Loans are very important to the proper functioning of the financial systems of the world. Like all debt instruments, a loan entails the redistribution of financial assets over time, between the lender and the borrower. With a loan, the borrower initially receives or borrows an amount of money, called the principal, from the lender, and is obligated to pay back or repay an equal amount of money to the lender at a later time. Typically, the money is paid back in regular installments or partial repayments. A loan is generally provided at a cost, referred to as interest on the debt, which provides an incentive for the lender to engage in the loan.

There are different types of loans including credit card, debit card, mortgage, home equity, automobile, consumer finance, and student loans. As an example, a credit card typically entitles its holder to buy goods and services based on the holder's promise to pay for these goods and services. The issuer of the card grants a line of credit to the consumer from which the consumer can borrow money for payment to a merchant or as a cash advance to the user. In order to encourage usage, many credit card customers receive rewards, e.g., frequent flyer points, gift certificates, or cash back, as an incentive to make purchases with the credit card. Depending on the type of card, rewards will generally cost the issuer between 0.25% and 2.0% of the spread and consequently rewards points may cut dramatically into an issuer's bottom line. Moreover, while reward points may encourage spending by consumers, reward points may have the unintended result of consumers overextending their financial capability. Thus, it is desirable that a reward program to encourage responsible spending in order to benefit both financial institutions as well as consumers.

### BRIEF SUMMARY

Aspects of the embodiments address one or more of the issues mentioned above by disclosing methods, computer readable media, and apparatuses that enable a financial institution (e.g., a credit card company) to award an account reward points when a customer remits a payment in a timely basis. Consequently, a financial institution encourages repayment of debt and recognizes good behavior through reward points every time a payment is received on-time. For example, each time a customer pays on-time, a credit card company may assign reward points to the customer's account for the amount of the payment. The amount of dollars paid may include principal, interest, and finance charges.

With another aspect of the embodiments, when a payment for a loan has been received in accordance with a reward policy, a number of reward points may be awarded to a customer that is dependent on a payment amount. With some embodiments, when the payment amount is at least as great as a minimum due and not greater than a balance due, setting the number of reward points to a constant multiplied by the payment amount. However, with other embodiments, reward points may be determined in a non-linear fashion. The customer may be provided a tangible reward, such as a monetary amount, based on the number of reward points.

With another aspect of the embodiments, reward points are awarded for purchases as well as for submitting a payment in accordance with a reward policy.

Aspects of the embodiments may be provided in a computer-readable medium having computer-executable instructions to perform one or more of the process steps described herein.

These and other aspects of the embodiments are discussed in greater detail throughout this disclosure, including the accompanying drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative operating environment in which various aspects of the invention may be implemented.

FIG. 2 is an illustrative block diagram of workstations and servers that may be used to implement the processes and functions of certain aspects of the present invention.

FIG. 3 shows a flow diagram in accordance with an aspect of the invention.

### DETAILED DESCRIPTION

In accordance with various aspects of the invention, methods, computer-readable media, and apparatuses are disclosed in which reward points are awarded to a credit card account when a customer remits a payment in a timely basis. The reward points may be redeemed for cash, gift, or some other tangible award. Consequently, a financial institution encourages repayment of debt and recognizes good behavior through reward points every time a payment is received on-time.

While the product construct is applicable to a credit card environments, embodiments may be extended to include other loan products, including mortgages, home equity, auto, and student loans.

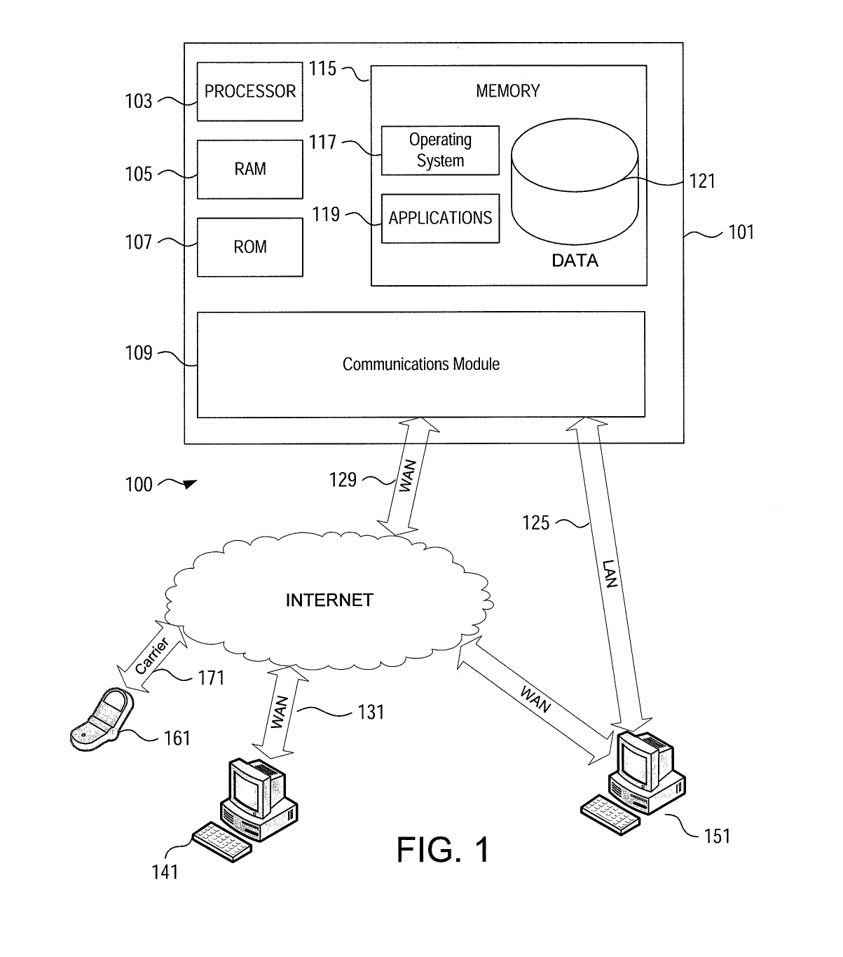

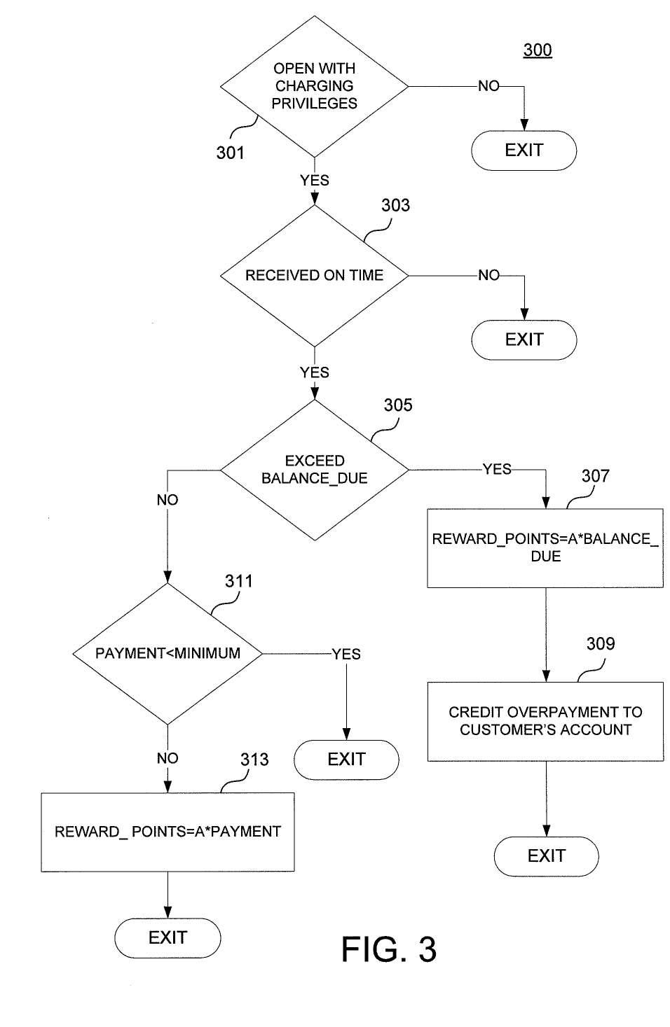

FIG. 1 illustrates an example of a suitable computing system environment 100 (e.g., for process 300 as shown in FIG. 3) that may be used according to one or more illustrative embodiments. The computing system environment 100 is only one example of a suitable computing environment and is not intended to suggest any limitation as to the scope of use or functionality of the invention. The computing system environment 100 should not be interpreted as having any dependency or requirement relating to any one or combination of components shown in the illustrative computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including RAM 105, ROM 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, etc. to digital files.

Although not shown, RAM 105 may include one or more are applications representing the application data stored in RAM memory 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of the computer executable instructions for computing device 101 may be embodied in hardware or firmware (not shown). Database 121 may provide centralized storage of loan information, e.g., credit card statements, that may be received from different points in system 100, e.g., computers 141 and 151 or from communication devices, e.g., communication device 161.

Computing device 101 may operate in a networked environment supporting connections to one or more remote computing devices, such as branch terminals 141 and 151. The branch computing devices 141 and 151 may be personal computing devices or servers that include many or all of the elements described above relative to the computing device 101. Branch computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 is connected to the LAN 825 through a network interface or adapter in the communications module 109. When used in a WAN networking environment, the server 101 may include a modem in the communications module 109 or other means for establishing communications over the WAN 129, such as the Internet 131. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. The network connections may also provide connectivity to a CCTV or image/iris capturing device.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the invention may include forms of computer-readable media. Computer-readable media include any available media that can be accessed by a computing device 101. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the invention is contemplated. For example, aspects of the method steps disclosed herein may be executed on a processor on a computing device 101. Such a processor may execute computer-executable instructions stored on a computer-readable medium.

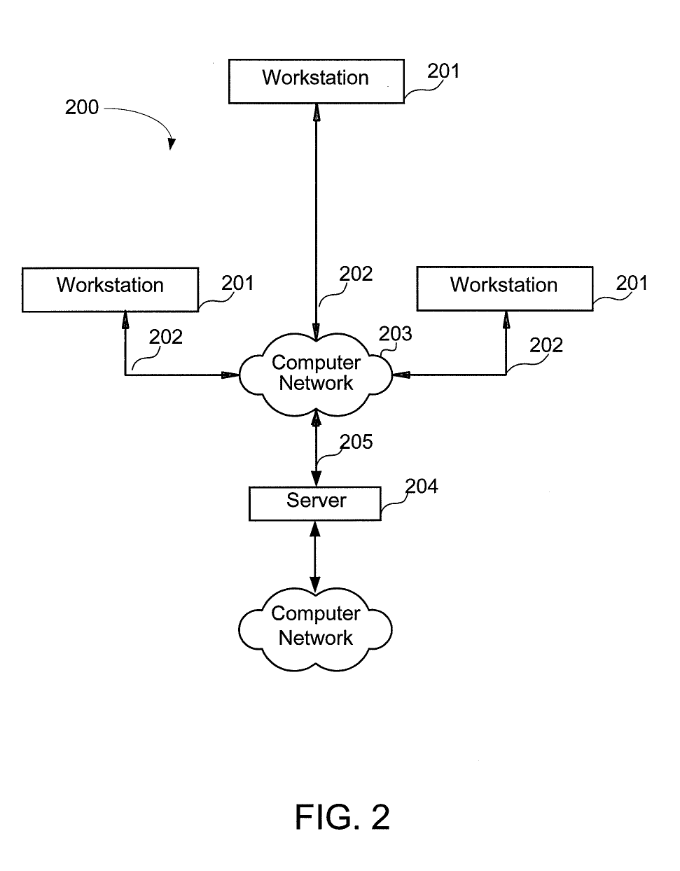

Referring to FIG. 2, an illustrative system 200 for implementing methods according to the present invention is shown. As illustrated, system 200 may include one or more workstations 201. Workstations 201 may be local or remote, and are connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc. Connectivity may also be supported to a CCTV or image/iris capturing device.

The steps that follow in the Figures may be implemented by one or more of the components in FIGS. 1 and 2 and/or other components, including other computing devices.

FIG. 3 shows flow diagram 300 in accordance with an aspect of the invention. Process 300 enables a financial institution (e.g., a credit card company) to award an account reward points when a customer remits a payment in a timely basis. Consequently, a financial institution encourages repayment of debt and recognizes good behavior through reward points every time a payment is received on-time. For example, each time a customer pays on-time, a credit card company assigns reward points to the customer's account for the amount of the payment. Reward points may be awarded in proportion to the amount of the payment, e.g., a $200 payment allows a customer to earn 200 reward points. However, embodiments may support different values for the constant of proportionality (e.g., 1 point per dollar paid, 0.5 point per dollar paid, or 2 points per dollar paid.) The amount of dollars paid may include principal, interest, and finance charges.

Reward points may be limited to payments that are at least equal to the minimum balance due but no more than the total balance due. When a payment exceeds the balance due, the account may be awarded reward points for the balance due while the excess amount is credited to the customer.

While some embodiments may award points in proportion to the dollars paid, other embodiments may award reward points in a non-linear fashion. For example, 0.5 points may be awarded for the first hundred dollars paid while 1 point may be awarded for every additional dollar paid. As another example, reward points may be determined differently for the principal paid, the interest paid, and the finance charges paid.

While the product construct is applicable to credit card environments, embodiments may be extended to include other loan products, including mortgages, home equity, auto, consumer finance, and student loans.

Referring to FIG. 1, processor 103 may execute process 300 in order to process credit card statements stored on data storage device 121. Credit card transactions may be performed at different computer devices (e.g., computer 141) through area network 131 through communications module 109.

When processing a credit card statement, processor 103 determines whether the credit card is open with charging privileges (i.e., the credit card is in good standing) in step 301. If not, no reward points are awarded even if the customer remits a payment in a timely basis as determined in step 303. If the payment is not received on time, no reward points are awarded.

Step 305 determines if the payment exceeds the balance due. If so, reward points are given only for the balance due in step 307 while the overpayment is credited to the customer's account in step 309. In such a case, the overpayment may be applied to a subsequent payment.

In step 307, A is a constant of proportionality, in which A points are awarded for each dollar paid. For example, if a customer pays the entire balance by the due date and A equals one, the customer receives as many reward points as when reward points are awarded for purchases.

Payment may include principal, interest, and finance charges. With some embodiments, the reward points are awarded in step 307 at the time that the payment is received and not at the time of the purchase.

If step 305 determines that the payment does not exceed the balance due, step 311 determines if the payment is less than the minimum due. If so, no reward points are awarded. Otherwise, reward points are awarded for the entire payment in step 313. With some embodiments, the reward points cannot be forfeited for a predetermined time period (e.g., within five years after the reward points are earned) once the reward points have been awarded in steps 313 and 307. Consequently, the reward points may be forfeited if the reward points have not been redeemed after the predetermined time period. With some embodiments, the rewards points may be forfeited based on the account status of the customer, e.g., the account is delinquent or the account is not open to purchase.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments. They may determine that the requirements should be applied to third party service providers (e.g., those that maintain records on behalf of the company).

1. A computer-assisted method comprising:
determining, by a computer system, whether a payment for a loan has been received in accordance with a reward policy, said payment comprising a payment amount; and
awarding to the customer, by the computer system, a number of reward points based on the payment amount.

2. The method of claim 1 further comprising:
converting the number of reward points to a monetary amount.

3. The method of claim 1, further comprising:
when the payment amount is at least as great as a minimum due and not greater than a balance due, setting the number of reward points to a constant multiplied by the payment amount.

4. The method of claim 1, further comprising:
setting the number of reward points to a first constant multiplied by the payment amount when the payment amount is less than a predetermined amount; and
setting the number of reward points to a second constant multiplied by the payment amount when the payment amount is not less than the predetermined amount, wherein the first and second constants are different.

5. The method of claim 1, further comprising:
awarding additional reward points for a purchase that is associated with the loan.

6. The method of claim 1, wherein the determining comprises:
when the payment occurs after a predetermined due date, excluding the payment from eligibility for award points.

7. The method of claim 1, wherein the loan is associated with a credit card and the determining comprises:
only when the consumer uses the credit card at least a predetermined number of times per time period, including the payment for the award points.

8. The method of claim 1, wherein the determining comprises:
when the payment is less than a predetermined minimum amount, excluding the payment for the award points.

9. The method of claim 1, further comprising:
excluding a portion of the payment that exceeds a current balance for the award points.

10. The method of claim 1, wherein the payment includes a principal component, an interest component, and a financial charge component and the awarding comprises:
differently determining the reward points for the payment components.

11. The method of claim 1, wherein a loan product associated with the loan is one of a mortgage loan, a home equity loan, a vehicle loan, a consumer finance loan, and a student loan.

12. An apparatus comprising:
at least one memory; and
at least one processor coupled to the at least one memory and configured to perform, based on instructions stored in the at least one memory:
when a payment for a loan is paid by a customer in accordance with a reward policy, awarding a number of reward points based on a payment amount, said payment comprising the payment amount; and
providing a tangible reward based on the number of reward points.

13. The apparatus of claim 12, wherein the at least one processor is further configured to perform:
when the payment amount is at least as great as a minimum due and not greater than a balance due, setting the number of reward points to a constant multiplied by the payment amount.

14. The apparatus of claim 12, wherein the at least one processor is further configured to perform:
setting the number of reward points to a first constant multiplied by the payment amount when the payment amount is less than a predetermined amount; and
setting the number of reward points to a second constant multiplied by the payment amount when the payment amount is not less than the predetermined amount, wherein the first and second constants are different.

15. The apparatus of claim 12, wherein the at least one processor is further configured to perform:
additionally rewarding the number of reward points for a purchase that is associated with the loan.

16. The apparatus of claim 12, wherein the at least one processor is further configured to perform:
differently determining the reward points for payment components, wherein the payment components include a principle component, an interest component, and a financial charge component.

17. The apparatus of claim 12, wherein the loan is associated with a credit card and the at least one processor is further configured to perform:
only when the consumer uses the credit card at least a predetermined number of times per time period, including the payment for the award points.

18. A computer-readable storage medium storing computer-executable instructions that, when executed, cause a processor to perform a method comprising:
determining whether a payment for a loan has been received in accordance with a reward policy, said payment comprising a payment amount;
when the payment for the loan is paid by a customer in accordance with the reward policy, awarding a number of reward points to the customer based on the payment amount; and
converting the number of reward points to a monetary amount.

19. The computer-readable medium of claim 18, said method further comprising:
when the payment amount is at least as great as a minimum due and not greater than a balance due, setting the number of reward points to a constant multiplied by the payment amount.

20. The computer-readable medium of claim 18, said method further comprising:
setting the number of reward points to a first constant multiplied by the payment amount when the payment amount is less than a predetermined amount; and
setting the number of reward points to a second constant multiplied by the payment amount when the payment amount is not less than the predetermined amount, wherein the first and second constants are different.

21. The computer-readable medium of claim 18, said method further comprising:
differently determining the reward points for payment components, wherein the payment components include a principle component, an interest component, and a financial charge component.

22. A computer-assisted method comprising:
determining, by a computer system, whether a payment for a credit card loan has been received in accordance with a reward policy, said payment comprising a payment amount, said payment amount including a fee associated with the credit card loan;
when the payment amount is at least as great as a minimum due and not greater than a balance due, setting a number of reward points to a constant multiplied by the payment amount; and
converting the number of reward points to a monetary amount.

23. A computer-assisted method comprising:
determining, by a computer system, whether a payment for a mortgage loan has been received in accordance with a reward policy, said payment comprising a payment amount; and
when the payment amount is at least as great as a minimum due and not greater than a balance due, awarding a number of reward points based on the payment amount.

24. The method of claim 23, wherein the awarding comprises:
setting the number of reward points to a constant multiplied by the payment amount.

25. The method of claim 23, wherein the awarding comprises:
setting the number of reward points to a first constant multiplied by the payment amount when the payment amount is less than a predetermined amount; and
setting the number of reward points to a second constant multiplied by the payment amount when the payment amount is not less than the predetermined amount, wherein the first and second constants are different.

26. The method of claim 23, further comprising:
providing a tangible award based on the number of reward points.

27. The method of claim 1, wherein the reward points are non-forfeitable during a predetermined time period after the reward points have been rewarded for an account of the customer and when a status of the account is satisfactory.
